(19) United States
(12) Patent Application Publication
(10) Pub. No.: US 2003/0138007 A1
(43) Pub. Date: Jul. 24, 2003

(54) Method and system for stabilizing wavelength and optical power of optical channels in WDM optical communication system

(75) Inventors: Yong-Tak Lee, Kwanju (KR); Young-Shik Kang, Kwanju (KR)

Correspondence Address: OLIFF & BERRIDGE, PLC, P.O. BOX 19928, ALEXANDRIA, VA, 22320, US

(73) Assignee: KWANGJU INSTITUTE OF SCIENCE AND TECHNOLOGY, Buk-gu (KR)

(21) Appl. No.: 10/099,961

(22) Filed: Mar. 19, 2002

(30) Foreign Application Priority Data
Jan. 21, 2002 (KR) 2002-3423

(51) Int. Cl. H01S 3/13

(52) U.S. Cl. 372/32

(57) ABSTRACT

Disclosed is a wavelength stabilizing method in which a first QCSE photodetector and a second QCSE photodetector receive a light outputted from a single light source, a first wavelength-photocurrent graph obtained when a selected bias voltage is applied to the first QCSE photodetector and a second wavelength-photocurrent graph obtained when a selected bias voltage is applied to the first QCSE photodetector are overlapped at a predetermined reference wavelength, a photocurrent outputted from the first QCSE photodetector is greater than a photocurrent outputted from the second QCSE photodetector at wavelengths shorter than the overlapped point while the photocurrent outputted from the second QCSE photodetector is greater than the photocurrent outputted from the first QCSE photodetector at wavelengths longer than the overlapped point, and if the photocurrent outputted from the first QCSE photodetector is greater than the photocurrent output from the second QCSE photodetector, output wavelengths are moved to the longer wavelengths side from the single light source, while if the photocurrent outputted from the second QCSE photodetector is greater than the photocurrent outputted from the first QCSE photodetector, the output wavelengths are moved to the shorter wavelengths side, thereby allowing the light outputted from the single light source to maintain the reference wavelength.

### BACKGROUND OF THE INVENTION

1. Field of the Invention

The present invention relates to method and system for stabilizing wavelength/power of an optical channel, and more particularly, to method and system for stabilizing wavelength and optical power using two Quantum Confined Starks Effect(QCSE) photodetectors in a WDM optical communication system.

2. Related Art

Recently, to realize ultra high speed and ultra large capacity optical communication system, wavelength division multiplexing (WDM) method is frequently being used. In order to realize wide communication band in the WDM optical communication system, it is necessary to sufficiently stabilize beams having multiple wavelengths and thereby sufficiently shorten an interval between wavelengths so that the wavelength of a laser as a light source can receive channels as many as possible within a relatively narrow communication band where amplification is possible by an EDFA.

In WDM systems channel spacings are standardized corresponding to integer multiple of 25 Ghz,i.e., 25 Ghz, 50 Ghz, 100 Ghz, etc. Currently, channel spacing of 100 Ghz(0.8 nm) is mainly used but in order to stably transmit signals in the WDM communication method, respective wavelengths of a channel should be fixed within a range of an approximately 1/10 or so of the channel interval. In other words, variation of the wavelength should be within 0.08 nm (10 GHz).

In WDM communication system, distributed feedback laser diode (hereinafter referred to as ‘DFB LD’) is mainly used as the light source, and it has a characteristic in which central wavelength is slightly shifted depending on a variation in the surrounding environment, such as temperature, and degradation. Among these DFB LDs, approximately 10% or so is degenerated by the long-term use, which causes a variation in the wavelength within approximately ±0.4 nm. So, it is very difficult to pick out these degenerated DFB LDs.

FIGS. 1A and 1B are views illustrating a conventional wavelength stabilizing system using manual optical filters.

Referring to FIG. 1A, a laser beam outputted from an LD (Laser Diode) 10 is splitted into two beams by the first beam splitter 20. One of the beam from the first beam splitter 20 is then incident upon a second beam splitter 21, and is again divided into two beams, and the divided beams are respectively incident upon a first manual optical filter 30 and a second manual optical filter 31. As shown in FIG. 1B, the first manual optical filter 30 and the second manual optical filter 31 have different transmission characteristics with respect to the wavelength and accordingly, they have a constant wavelength range where the stabilization is requested around a reference wavelength λ₀.

The beams filtered by the first manual optical filter 30 and upon into a first photodetector 40 and a second photodetector 41, where they are converted into electrical signals, and are inputted into a comparator 50. The comparator 50 compares the inputted electrical signals and then outputs wavelength information capable of being perceived in FIG. 1B to an LD driving circuit 60. The LD driving circuit 60 which receives signals outputted from the comparator 50 controls an output wavelength of the LD 10 such that the output wavelength is constantly maintained at the reference wavelength λ₀.

For the aforementioned way to be possible, it is necessary for the two manual optical filters be properly designed with respect to the reference wavelength λ₀. However, since the manual optical filters have only fixed properties and the reference wavelength has a fixed value, it is impossible to use the manual optical filters in a system where the reference wavelength varies.

FIG. 2 is a block diagram illustrating a conventional wavelength stabilizing system using an optical fiber grating.

Referring to FIG. 2, a laser beam outputted from a DBR LD 11 is splitted into two optical paths by a first beam splitter 22.. One of the beam from the first beam splitter 22 is incident upon a second beam splitter 23, and is again divided into two optical paths, and the divided beams are respectively incident upon an optical fiber grating 70 and a first photodetector 42. As the beam is inputted into the first photodetector 42, the first photodetector 42 outputs an electrical signal (B) corresponding to the inputted beam to a divider 51, and the beam inputted to the optical fiber grating 70 is again outputted depending on light transmission characteristic of the optical fiber grating 70 and is inputted into a second photodetector 43. The second photodetector 43 outputs an electrical signal (A) corresponding to the inputted beam to the divider 51.

The divider 51 outputs the signals A/B to a comparator 52, and the comparator 52 compares the signals A/B with a reference signal V_{ref} and outputs the compared results to an adder 53 and a control device 61. An electrical signal inputted to the adder 52 is added to an external input direct current I_{DC} and is then outputted. A temperature control device 80 receives an amplified signal outputted from the adder 53 to thereby raise or drop the temperature of the DBR LD 11.

The signal inputted to the control device 61 controls a current supplied to a Bragg grating portion of the DBR LD 11 in order to change the light transmission characteristic of the Bragg grating of the DBR LD 11, and feedbacks the Bragg grating window of the DBR LD 11 to the reference wavelength.

Like the conventional wavelength stabilizing system using the manual optical filter, since the system of FIG. 2 also has a fixed wavelength transmission characteristic of the optical fiber grating, it is impossible to be used with the system in a system where there is a need to change the reference wavelength, and it is also difficult to manufacture an optical fiber grating capable of stabilizing wavelength.

FIG. 3 is a schematic view illustrating a conventional wavelength stabilizing system using a Fabry-Perot etalon filter.

Referring to FIG. 3, a beam outputted from a DFB LD 12 is focused on a lens 34, passes through a Fabry-Perot etalon filter 35, and is incident upon a first photodetector 44 and a second photodetector 45, respectively. At this time, the Fabry-Perot etalon filter 35 is not in parallel with the lens 34, it is slightly tilted with respect to the lens 34. Therefore, angles of beams that have passed the Fabry-Perot etalon filter 35 become different, so that transmission characteristics of the first photodetector 44 and the second photodetector 45 appear different from each other.

Electrical signals detected by the two photodetectors 44 and 45 are inputted into a comparator 54, are compared to each other, and the compared result is inputted into a laser driver 62. The laser driver 62 receives a signal from the comparator 54 and feedbacks a control signal that maintain an output wavelength of the DFB LD 12 at a constant value to the DFB LD 12.

The Fabry-Perot etalon filter 35 has an advantage in that one Fabry-Perot etalon filter can provide reference wavelengths of several channels, but a procedure for precisely adjusting the wavelengths is not easy and its volume is large and expensive. Further, because the Fabry-Perot filter 35 uses a bulk optical material, it has a disadvantage in that insertion loss is large.

As aforementioned, the conventional art places the manual optical filters 30 and 31, the optical fiber grating 70, the Fabry-Perot etalon filter, and the like ahead of the photodetectors and monitors wavelength of light source using transmission characteristic with respect to the wavelength in order to obtain information about wavelength of beam outputted from the light source.

However, in order to monitor the wavelength of the light source, at least two units of devices (filter+photodetector) are required, and also volume of the system become large and expensive. Especially, since the manual optical filters 30 and 31, the optical fiber grating 70 and the Fabry-Perot etalon filter 35 have a fixed transmission characteristic with respect to the wavelength, it is in fact impossible to stabilize them with respect to an arbitrary reference wavelength. Also, in order to monitor information about the optical power, additional device is required.

### SUMMARY OF THE INVENTION

Accordingly, it is an object of the invention to provide a method capable of stabilizing wavelength with a simple structure using a QCSE photodetector capable of carrying out both functions of the filter and the detector at the same time.

It is another object of the invention to provide a method of stabilizing an optical power using a QCSE photodetector.

It is still another object of the invention to provide a wavelength/power stabilizing system capable of varying a reference wavelength using a QCSE photodetector.

It is further still another object of the invention to provide a miniaturized wavelength/power stabilizing system by an integration.

To accomplish the above objects and other advantages, there is used a QCSE photodetector having both functions of the fabry-ferot filter and the photodetector instead of directly using the fabry-ferot filter and the photodetector. FIG. 4 shows an 1s exciton absorption characteristic of the QCSE. As shown in FIG. 4, the QCSE photodetector shows a characteristic in which absorption decreases near left and right sides of a peak wavelength, which is similar to transmission characteristic of a fabry-perot resonator. According to one aspect of the present invention, which provides a wavelength stabilizing method in which a first QCSE photodetector and a second QCSE photodetector receive a light outputted from a single light source. At this time, optical absorption characteristics of the first an second QCSE photodetectors are set such that they are slightly shifted as shown in FIG. 4, and thereby set to overlap each other. In other words, a first wavelength-photocurrent graph obtained when a selected bias voltage is applied to the first QCSE photodetector and a second wavelength-photocurrent graph obtained when a selected bias voltage is applied to the second QCSE photodetector are to overlap at a predetermined reference wavelength. A photocurrent outputted from the first QCSE photodetector is greater than a photocurrent outputted from the second QCSE photodetector at wavelengths shorter than the overlapped point while the photocurrent outputted from the second QCSE photodetector is greater than the photocurrent outputted from the first QCSE photodetector at wavelengths longer than the overlapped point. If the photocurrent outputted from the first QCSE photodetector is greater than the photocurrent outputted from the second QCSE photodetector, a beam having a wavelength longer than the reference wavelength is outputted from the single light source, while if the photocurrent outputted from the second QCSE photodetector is greater than the photocurrent outputted from the first QCSE photodetector, a beam having a wavelength shorter than the reference wavelength is outputted, thereby allowing the light outputted from the single light source to maintain the reference wavelength.

Like the conventional case using the characteristic of the Fabry-Perot etalon filter, two QCSE photodetectors having different optical absorption characteristics can be used. In this case, the two QCSE photodetectors should be manufactured through different processes from each other. In order to integrate two QCSE photodetectors having different light absorption characteristics, a quantum well intermixing technology or a selective area growth is preferably used. However, in case of the QCSE photodetector, although the two photodetectors have the identical light absorption characteristic, i.e., although the two photodetectors have the identical structure and material, it is possible to set optical absorption characteristic graphs to be shifted and overlapped at a reference wavelength as shown in FIG. 4 by applying different bias voltages to the respective photodectors.

According to another aspect of the invention, there is a light output stabilizing method in which a first QCSE photodetector and a second QCSE photodetector receive a light outputted from a single light source. The method comprises the steps of: comparing a sum of a first wavelength-photocurrent graph and a second wavelength-photocurrent graph with a predetermined reference value, the first wavelength-photocurrent graph being outputted from the first QCSE photodetector and the second wavelength-photocurrent graph being outputted from the second QCSE photodetector, respectively; and when the sum is smaller than the predetermined reference value, outputting a light having an intensity greater than a reference level while when the sum is greater than the predetermined reference value, outputting a light having an intensity smaller than the reference level, whereby an intensity of the light outputted from the single light source is maintained at a constant level.

According to further another aspect of the invention, there is provided a wavelength/light optical power stabilizing system comprising: an LD for outputting a laser beam; a first QCSE photodetector and a second QCSE photodetector for receiving the laser beam outputted from the LD and a bias voltage from an outside to represent characteristics of a first wavelength-photocurrent graph and a second wavelength-photocurrent graph, the first wavelength-photocurrent graph and the second wavelength-photocurrent graph being overlapped at a predetermined reference wavelength, photocurrent values of the first wavelength-photocurrent graph greater being greater than those of the second wavelength-photocurrent graph at wavelengths shorter than the overlapped point while the photocurrent values of the second wavelength-photocurrent graph being greater than those of the first wavelength-photocurrent graph at wavelengths longer than the overlapped point; a wavelength stabilizing comparator for comparing the photocurrent values respectively outputted from the first QCSE photodetector and the second QCSE photodetector, and outputting a compared result; a wavelength stabilizing temperature control part for receiving a signal outputted from the wavelength stabilizing comparator, and if the photocurrent value outputted from the first QCSE photodetector is different than the photocurrent value outputted from the second QCSE photodetector, changing the temperature of the LD such that the laser beam outputted from the LD to have the reference wavelength; an adder for outputting a signal value corresponding to a sum of the photocurrents respectively outputted from the first QCSE photodetector and the second QCSE photodetector; a power stabilizing comparator for comparing the signal value outputted from the adder with a predetermined reference value to output a compared result; and a power stabilizing driving control part for receiving a signal outputted from the power stabilizing comparator, and if the signal value outputted from the adder is different from the reference value, changing a driving current value of the LD such that an intensity of the laser beam outputted from the LD is changed, thereby stabilizing wavelength and intensity of the laser beam outputted from the LD.

According to still another aspect of the invention, there is provided a wavelength/ optical power stabilizing system comprising: a DBR LD for outputting a laser beam; a first QCSE photodetector and a second QCSE photodetector for receiving the laser beam outputted from the DBR LD and a bias voltage from an outside to represent characteristics of a first wavelength-photocurrent graph and a second wavelength-photocurrent graph, the first wavelength-photocurrent graph and the second wavelength-photocurrent graph being overlapped at a predetermined reference wavelength, photocurrent values of the first wavelength-photocurrent graph being greater than those of the second wavelength-photocurrent graph at wavelengths shorter than the overlapped point while the photocurrent values of the second wavelength-photocurrent graph being greater than those of the first wavelength-photocurrent graph at wavelengths longer than the overlapped point; a wavelength stabilizing comparator for comparing the photocurrent values respectively outputted from the first QCSE photodetector and the second QCSE photodetector, and outputting a comparing result; a wavelength stabilizing current control part for receiving a signal outputted from the wavelength stabilizing comparator, and if the photocurrent value outputted from the first QCSE photodetector is different than the photocurrent value outputted from the second QCSE photodetector, changing a current applied to a DBR portion of the DBR LD such that the laser beam outputted from the DBR LD to have the reference wavelength; an adder for outputting a signal value corresponding to a sum of the photocurrents respectively outputted from the first QCSE photodetector and the second QCSE photodetector; a power stabilizing comparator for comparing the signal value outputted from the adder with a predetermined reference value to output a comparing result; and a power stabilizing driving control part for receiving a signal outputted from the power stabilizing comparator, and if the signal value outputted from the adder is different than the reference value, changing a driving current value of the DBRLD such that an intensity of the laser beam outputted from the DBR LD is changed, thereby stabilizing wavelength and intensity of the laser beam outputted from the DBR LD.

According to further still another aspect of the invention, there is provided a wavelength/optical power stabilizing system comprising: a wavelength control integration module including (i) an LD for outputting a laser beam, (ii) a light power splitter for dividing the laser beam outputted from the LD, and (iii) a first QCSE photodetector and second QCSE photodetector for receiving beams respectively outputted from the light power splitter and a rear terminal of the LD and a bias voltage from an outside to represent characteristics of a first wavelength-photocurrent graph and a second wavelength-photocurrent graph, the first wavelength-photocurrent graph and the second wavelength-photocurrent graph being overlapped at a predetermined reference wavelength, photocurrent values of the first wavelength-photocurrent graph being greater than those of the second wavelength-photocurrent graph at wavelengths shorter than the overlapped point while the photocurrent values of the second wavelength-photocurrent graph being greater than those of the first wavelength-photocurrent graph at wavelengths longer than the overlapped point, the wavelength control integration module integrating the LD, the light power splitter, and a comparator; a temperature control circuit and thermoelectric cooler for receiving a signal outputted from the comparator and maintaining a temperature of the wavelength control integration module at a constant value; and an LD driver for receiving the signal outputted from the comparator, outputting a driving current to control a wavelength of the LD and inputting the driving current to the LD, thereby stabilizing wavelength and intensity of the laser beam outputted from the LD.

Preferably, the LD is a DFB LD or a DBR LD.

### BRIEF DESCRIPTION OF THE DRAWINGS

The above objects and other advantages of the present invention will become more apparent by describing in detail preferred embodiments thereof with reference to the attached drawings in which:

FIGS. 1A and 1B are views illustrating a conventional wavelength stabilizing system using manual optical filters;

FIG. 2 is a block diagram illustrating a conventional wavelength stabilizing system using an optical fiber grating;

FIG. 3 is a schematic view illustrating a conventional wavelength stabilizing system using a Fabry-Perot etalon filter;

FIG. 4 is a graph showing absorption characteristic of 1s exciton in QCSE photodetectors;

FIGS. 5A and 5B are graphs illustrating a wavelength stabilizing method in accordance with the present invention;

FIG. 5C is a graph showing absorption spectra of 1s exciton obtained when 5V is applied to the first QCSE photodetector and 7V is applied to the second photodetector in FIGS. 5A and 5B;

FIG. 6 is a sectional view of a QCSE photodetector having a p-i-n structure;

FIG. 7 is a schematic view illustrating a wavelength/optical power stabilizing system in accordance with one preferred embodiment of the present invention; and

FIG. 8 is a schematic view illustrating a wavelength/optical power stabilizing system in accordance with another preferred embodiment of the present invention, and shows a case in which two QCSE photodetectors are integrated with a DFB LD.

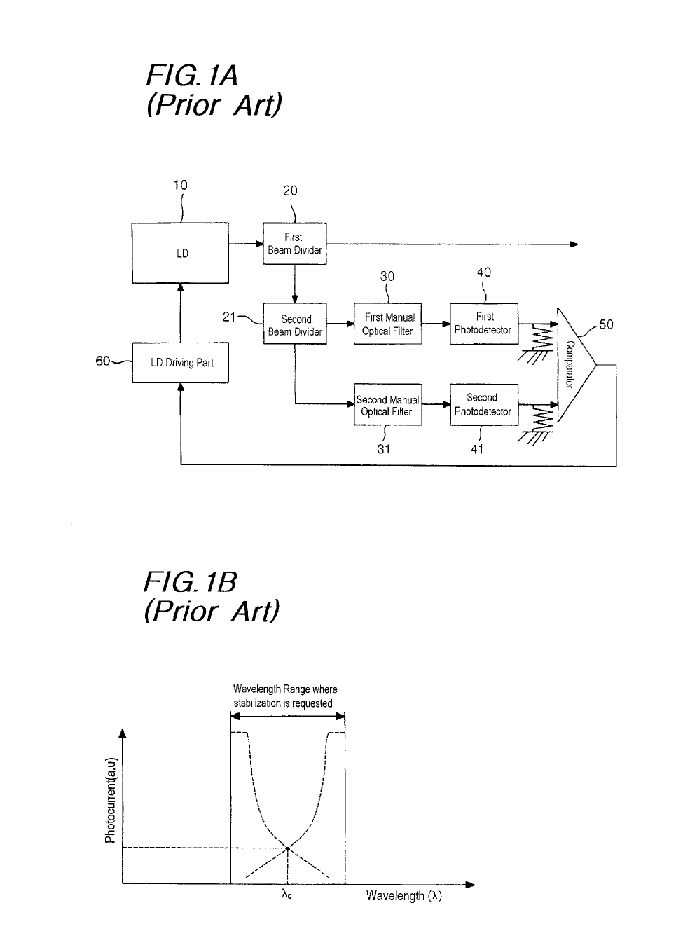

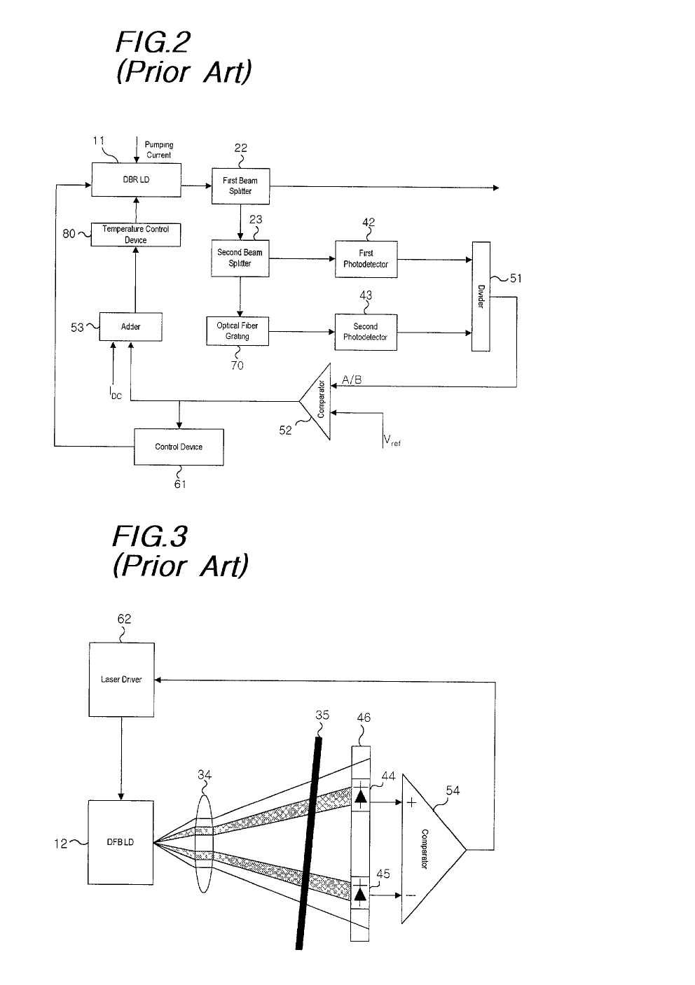

### DETAILED DESCRIPTION OF THE PREFERRED EMBODIMENT

Preferred embodiments will be described with reference to the accompanying drawings.

Embodiment 1

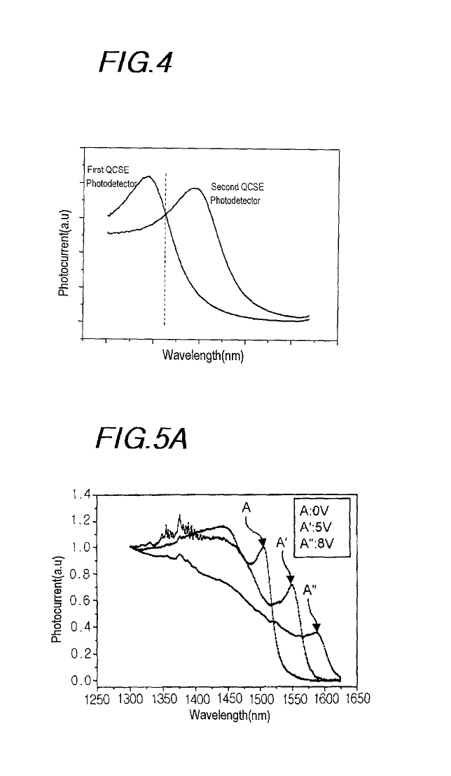

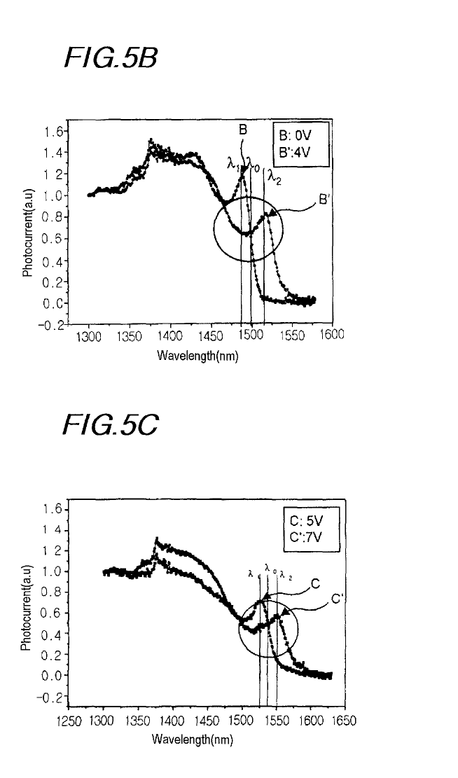

FIGS. 5A and 5B are graphs illustrating a wavelength stabilizing method in accordance with the present invention. Specifically, FIG. 5A shows absorption spectra of 1s exciton depending on a voltage applied to a single QCSE photodetector.

Referring to FIG. 5A, as a beam is incident upon a QCSE photodetector, an electron in the valence band absorbs an energy of the incident beam and is transited to the conduction band, so that an electrical signal, i.e., photocurrent is generated. By detecting this photocurrent and monitoring an absorption spectrum, it is possible to view a peak of 1s exciton. This exciton is a pair of electron and hole acting as a single particle by a weak coulomb force. Energy absorbed by the excition is a little smaller than energy of quantum well band interval. Accordingly, an effect due to the exciton is generated at the longer wavelengths side on the absorption spectrum.

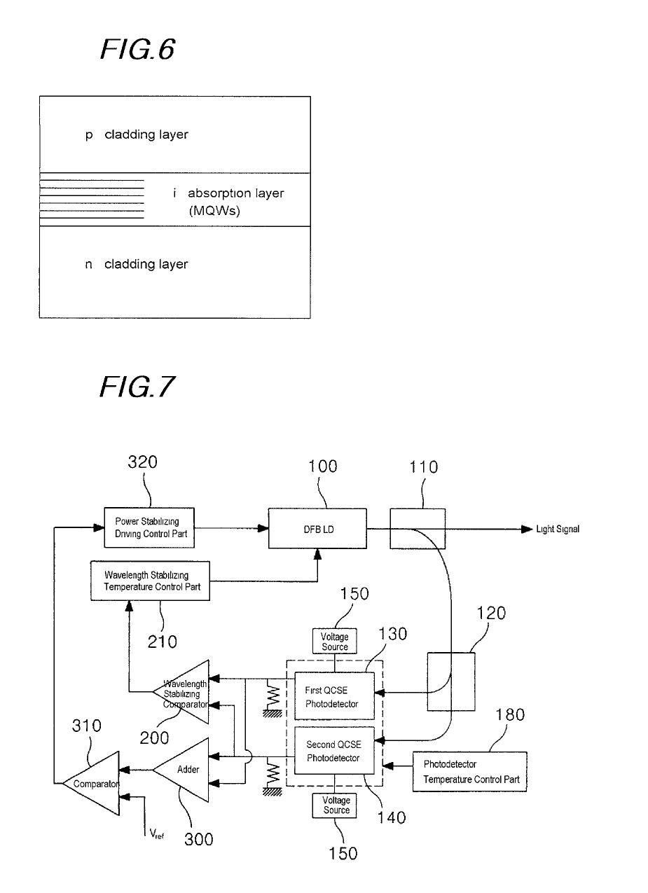

QCSE photodetector is a semiconductor photodetector with quantum well structure using quantum confined stark effect. As shown in FIG. 6, QCSE photodetector is made in a p-i-n structure. Since the QCSE photodetector hardly has any dark current when reverse bias is applied, it is very good in detecting photocurrent of the incident beam. Here, i-layer acts as light absorption layer of the QCSE photodetector, and generally has a multiple quantum wells structure in which materials having high band gap and low band gap, such as InGaAs/InAlAs are periodically layered.

QCSE is a phenomenon that when 1s exciton absorption spectrum is abruptly varied depending on the wavelength, and reverse bias is applied to the photodetector, full width half minimum is widened.

In the QCSE photodetector, 1s exciton absorption spectrum can be also viewed at room temperature as shown in FIG. 5A. As the bias voltage is elevated to 0V, 5V and 8V as indicated by the symbols A, A′ and A″, it is shown that position of the exciton peak is shifted to the longer wavelength side. Accordingly, it becomes possible to place position of exciton peak in the QCSE photodetector within an appropriate wavelength range by controlling the voltage applied to the QCSE photodetector. Of course, the position of the exciton peak may be varied according to the width of the quantum well, materials constituting the well and barrier, etc.

FIG. 5B shows absorption spectra of 1s exciton when different bias voltages are applied to two identical QCSE photodetectors. Specifically, beams irradiated from a single laser diode (LD) are respectively incident upon a first photodetector and a second photodetector, and 0V is applied to the first QCSE photodetector and 4V is applied to the second QCSE photodetector such that two absorption spectra are overlapped at a reference wavelength λ₀, so that graphs B and B′ are obtained.

Referring to FIG. 5B, photocurrent amounts generated from the first QCSE photodetector and second QCSE photodetector are identical at λ₀, a photocurrent amount generated from the first QCSE photodetector is greater than that generated from the second QCSE photodetector at λ₁ shorter in wavelength than λ₀, and the photocurrent amount generated from the second QCSE photodetector is greater than that generated from the first QCSE photodetector at λ₂ longer in wavelength than λ₀.

Accordingly, if the photocurrent generated from the first QCSE photodetector is greater than that generated from the second QCSE photodetector, a feed-back signal is sent to the light source such that a beam having the longer wavelength is outputted from the light source, while if the photocurrent generated from the second QCSE photodetector is greater than that generated from the first QCSE photodetector, the feed-back signal is sent to the light source such that a beam having the shorter wavelength is outputted from the light source, thereby allowing the beam outputted from the light source to maintain the reference wavelength λ₀.

FIG. 5C shows absorption spectra of 1s exciton obtained when 5V is applied to the first QCSE photodetector and 7V is applied to the second photodetector. In FIG. 5C, it is shown that graphs are slightly shifted to the right side and thereby the reference wavelength λ₀ is changed into λ₀′. Thus, by applying an appropriate bias voltage to the two photodetectors, it is possible to allow the reference wavelength to have a desired value.

Of course, since the exciton absorption spectrum is varied by width of quantum well, materials constituting the well and barrier, temperature, etc., FIG. 5B and FIG. 5C have the same variables except for the bias voltage, i.e., only the bias voltage is varied.

Although equivalent bias voltages are applied, if the QCSE photodetectors as used have different structures, graphs as shown in FIG. 5B can be obtained. In this case, it is naturally possible to obtain identical effect to the present invention. However, since use of identical photodetectors and application of different bias voltages can change the value of λ₀ with ease, it is more proper for tunable wavelengths.

Embodiment 2

FIG. 7 is a schematic view illustrating a wavelength/optical power stabilizing system in accordance with one preferred embodiment of the present invention.

Referring to FIG. 7, a laser beam outputted from a DFB LD 100 is divided into two optical paths by a first beam splitter 110. One of the two optical paths is incident upon a second beam splitter 120 and is again divided into two optical paths, and the divided beams are respectively incident upon a first QCSE photodetector 130 and a second QCSE photodetector 140. The first QCSE photodetector and second QCSE photodetector receive different bias voltages from a voltage source 150 and show different transmission characteristics. Hereinafter, for the convenience of description, it is regarded that their transmission characteristics are the same as that of FIG. 5B.

A wavelength stabilizing comparator 200 compares photocurrent values respectively outputted from the first QCSE photodetector and second QCSE photodetector and outputs a compared result. As described in FIG. 5B, if the photocurrent generated from the first QCSE photodetector 130 is greater than that generated from the second QCSE photodetector 140, the wavelength stabilizing comparator 200 allows a beam having the longer wavelength to be outputted from the DFB LD 100, while if the photocurrent generated from the second QCSE photodetector is greater than that generated from the first QCSE photodetector, the wavelength stabilizing comparator 200 allows a beam having the shorter wavelength to be outputted from the DFB LD 100, so that the beam outputted from the DFB LD 100 maintains the reference wavelength λ₀.

A wavelength stabilizing temperature control part 210 receives a signal outputted from the wavelength stabilizing comparator 200. If the photocurrent value outputted from the first QCSE photodetector 130 is different than the photocurrent value outputted from the second QCSE photodetector 140, the wavelength stabilizing temperature control part 210 changes a temperature of the DFB LD 100 such that the laser beam outputted from the DFB LD 100 maintains the reference wavelength λ₀.

The DFB LD has a property in which wavelength thereof is constantly varied with temperature, which is called temperature-tuning coefficient of the DFB LD and is well known to have a value ranged from 9.5 GHz/°C. to 10 GHz/° C. These values correspond to approximately 0.1 nm/° C. when converted with respect to the reference wavelength of 1,550 nm.

For instance, when the wavelength of the beam outputted from the DFB LD 100 is shifted from λ₀ to λ₂, the wavelength stabilizing temperature control part 210 drops the temperature of the DFB LD 100, whereas when the wavelength of the beam outputted from the DFB LD 100 is shifted from λ₀ to λ₁, the wavelength stabilizing temperature control part 210 raises the temperature of the DFB LD 100, thereby allowing the beam outputted from the DFB LD 100 to maintain the reference wavelength λ₀.

Since the transmission characteristics of the first and second QCSE photodetectors 130 and 140 may be varied with temperature, the wavelength stabilizing system is preferably provided with a photodetector temperature control part 180.

An adder 300 outputs a signal value corresponding to a sum of the photocurrent values respectively outputted from the first QCSE photodetector 130 and the second QCSE photodetector 140. A power stabilizing comparator 310 compares the signal value outputted from the adder 300 with a predetermined reference value to output a compared result. For instance, the adder 300 converts a photocurrent value into a voltage value and transmits the converted voltage value to the power stabilizing comparator 310, and the power stabilizing comparator 310 compares this voltage value with a predetermined reference voltage value V_{ref}.

A power stabilization driving control part 320 receives a signal outputted from the power stabilizing comparator 310, and if the signal value outputted from the adder 300 is different from the reference voltage value, the power stabilizing driving control part 320 changes a driving current value of the DFB LD 100 such that an intensity of the laser beam output from the DFB LD 100 is changed, thereby allowing the laser beam outputted from the DFB LD 100 to have a constant intensity.

Thus, when the DFB LD and the QCSE photodetectors are integrated, if there is a variation in the wavelength of output beam, the system stabilizes the wavelength by changing the temperature of the DFB LD, whereas if there is a variation in the beam power, the system stabilizes the beam power by controlling a driving current amount of the DFB LD, thereby stabilizing the wavelength and the beam power.

Embodiment 3

FIG. 7 describes the example of the case where the DFB LD is used as the light source, but if a DBR LD is used as the light source, a wavelength stabilizing system should have a different constitution than that of FIG. 7. In case of DBR LD, wavelength variation of output beam occurs by an applied amount of current to a DBR portion as well as temperature of the DBR LD. Accordingly, when the wavelength stabilizing comparator 200 determines that the photocurrent value of the first QCSE photodetector 130 is different from that of the second QCSE photodetector 140, it should be needed to control the temperature of the DBR LD and the current amount applied to the DBR portion. In order to obtain a wavelength stabilization in a state that temperature of the DBR LD is constant, it is needed to control only the current amount applied to the DBR portion. In this case, it is allowed to install a wavelength stabilizing current control part instead of the wavelength stabilizing temperature control part 210 provided in FIG. 7.

Accordingly, when the DBR LD and the QCSE photodetectors are integrated, if there is a variation in the wavelength of output beam, the system stabilizes the wavelength by controlling a current amount applied to the DBR portion, whereas if there is a variation in the beam power, the system stabilizes the beam power by controlling a driving current amount of the DFB LD.

Embodiment 4

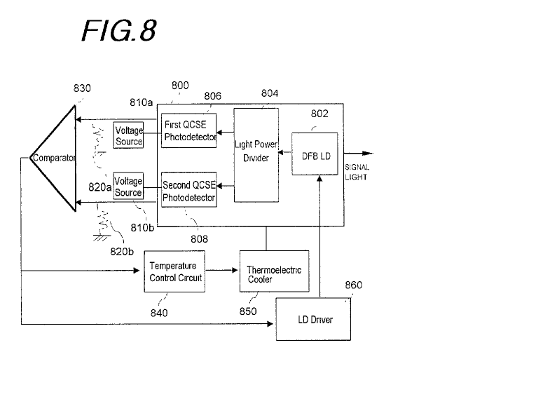

FIG. 8 is a schematic view showing a case where two QCSE photodetectors are integrated with a DFB LD as a signal source. Unlike the embodiment 3, since the present embodiment does not divide a signal light but uses a light irradiated from a rear terminal of a DFB LD 802, it is possible to monitor the wavelength without decreasing the power of the light source. The wavelength/light power stabilizing system of FIG. 8 includes a wavelength control integration module 800 on which the DFB LD 802, a light power splitter 804, and first and second QCSE photodetectors 806 and 808 are integrated, voltage sources 810a and 810b, resistances 820a and 820b, a comparator 830, a temperature control circuit 840, a thermoelectric cooler 850, and a DFB LD driver 860.

The system of FIG. 8 has the same operation principle as that of the embodiment 2, but it has a difference in that the first and second QCSE photodetectors 806 and 808, the DFB LD 802 as the signal source, and the light power divider 804 are integrated. Here, it is noted that since QCSE of the first and second QCSE photodetectors 806 and 808 has a characteristic that varies with temperature, their temperatures should be constantly maintained. Accordingly, the temperature control circuit 840 which receives an output signal from the comparator 830, and the thermoelectric cooler 850 are used to maintain the temperature of the wavelength control integration module 800 at a constant value.

Meanwhile, since it becomes impossible to control the wavelength of the DFB LD 802 through the temperature, the wavelength should be controlled by a driving current. Thus, it is possible to monitor the light power but it becomes impossible to constantly control the light power. Also, the DFB LD 802 serving as the signal source in FIG. 7 can be replaced with the DBR LD. The DBR LD can control the wavelength of the output light by controlling a current applied to the DBR portion with maintaining temperature thereof at a constant value, and it can a1s o control the light power by varying the driving current. Accordingly, although the DBR LD is integrated, it can control the wavelength and the light power simultaneously.

As described above, according to the present invention, there are used two QCSE photodetectors capable of carrying out both functions of the filter and the detector at the same time, so that the constitution of the system is simplified and stabilization of wavelength and light power is realized. Also, since it is possible to easily change the reference wavelength λ₀ through the control of the bias voltage values applied to the QCSE photodetectors, stabilization of wavelength can be easily realized with respect to an arbitrary reference wavelength.

Although the preferred embodiments of the present invention have been disclosed for illustrative purposes, those skilled in the art will appreciate that various modifications, additions and substitutions can be made without departing from the scope and spirit of the invention as defined in the accompanying claims.

What is claimed is:

1. A wavelength stabilizing method in which a first QCSE photodetector and a second QCSE photodetector receive a light outputted from a single light source, a first wavelength-photocurrent graph obtained when a selected bias voltage is applied to the first QCSE photodetector and a second wavelength-photocurrent graph obtained when a selected bias voltage is applied to the first QCSE photodetector are overlapped at a predetermined reference wavelength, a photocurrent outputted from the first QCSE photodetector is greater than a photocurrent outputted from the second QCSE photodetector at wavelengths shorter than the overlapped point while the photocurrent outputted from the second QCSE photodetector is greater than the photocurrent outputted from the first QCSE photodetector at wavelengths longer than the overlapped point, and if the photocurrent outputted from the first QCSE photodetector is greater than the photocurrent output from the second QCSE photodetector, output wavelengths are moved to the longer wavelengths side from the single light source, while if the photocurrent outputted from the second QCSE photodetector is greater than the photocurrent outputted from the first QCSE photodetector, the output wavelengths are moved to the shorter wavelengths side, thereby allowing the light outputted from the single light source to maintain the reference wavelength.

2. The method of claim 1, wherein the first wavelength-photocurrent graph and the second wavelength-photocurrent graph are obtained based on a peak of is exciton.

3. The method of claim 1, wherein the first QCSE photodetector and second QCSE photodetector are same from each other, but bias voltages respectively applied to the first QCSE photodetector and the second QCSE photodetector are different from each other.

4. The method of claim 1, wherein the single light source is a DFB LD or a DBR LD.

5. An optical power stabilizing method in which a first QCSE photodetector and a second QCSE photodetector receive a light outputted from a single light source, the method comprising the steps of:
comparing a sum of a first wavelength-photocurrent graph and a second wavelength-photocurrent graph with a predetermined reference value, the first wavelength-photocurrent graph being outputted from the first QCSE photodetector and the second wavelength-photocurrent graph being outputted from the second QCSE photodetector, respectively; and
when the sum is smaller than the predetermined reference value, outputting a light having an intensity greater than a reference level while when the sum is greater than the predetermined reference value, outputting a light having an intensity smaller than the reference level, whereby an intensity of the light outputted from the single light source is maintained at a constant level.

6. A wavelength/optical power stabilizing system comprising:
a LD for outputting a laser beam;
a first QCSE photodetector and a second QCSE photodetector for receiving the laser beam outputted from the LD and a bias voltage from an outside to represent characteristics of a first wavelength-photocurrent graph and a second wavelength-photocurrent graph, the first wavelength-photocurrent graph and the second wavelength-photocurrent graph being overlapped at a predetermined reference wavelength, photocurrent values of the first wavelength-photocurrent graph greater being greater than those of the second wavelength-photocurrent graph at wavelengths shorter than the overlapped point while the photocurrent values of the second wavelength-photocurrent graph being greater than those of the first wavelength-photocurrent graph at wavelengths longer than the overlapped point;
a wavelength stabilizing comparator for comparing the photocurrent values respectively outputted from the first QCSE photodetector and the second QCSE photodetector, and outputting a compared result;
a wavelength stabilizing temperature control part for receiving a signal outputted from the wavelength stabilizing comparator, and if the photocurrent value outputted from the first QCSE photodetector is different from the photocurrent value outputted by the second QCSE photodetector, changing the temperature of the LD such that the laser beam outputted from the LD has the reference wavelength;
an adder for outputting a signal value corresponding to a sum of the photocurrents respectively outputted from the first QCSE photodetector and the second QCSE photodetector;
a power stabilizing comparator for comparing the signal value outputted from the adder with a predetermined reference value to output a compared result; and
a power stabilizing driving control part for receiving a signal outputted from the power stabilizing comparator, and if the signal value outputted from the adder is different from the reference value, changing a driving current value of the LD such that an intensity of the laser beam outputted from the LD is changed, thereby stabilizing wavelength and intensity of the laser beam outputted from the LD.

7. The wavelength/optical power stabilizing system of claim 6, wherein the LD is a DFB LD.

8. The wavelength/optical power stabilizing system of claim 6, wherein the wavelength stabilizing temperature control part raises the temperature of the LD when the first QCSE photodetector outputs a photocurrent greater than the second QCSE photodetector while the wavelength stabilizing temperature control part drops the temperature of the LD when the second QCSE photodetector outputs a photocurrent greater than the first QCSE photodetector.

9. The wavelength/optical power stabilizing system of claim 6, wherein the first QCSE photodetector has a different beam absorption characteristic than the second QCSE photodetector, and the first QCSE photodetector and second QCSE photodetector are integratedly formed by a quantum well intermixing technology or a selective growth.

10. A wavelength/optical power stabilizing system comprising:
a DBR LD for outputting a laser beam;
a first QCSE photodetector and a second QCSE photodetector for receiving the laser beam outputted from the DBR LD and a bias voltage from an outside to represent characteristics of a first wavelength-photocurrent graph and a second wavelength-photocurrent graph, the first wavelength-photocurrent graph and the second wavelength-photocurrent graph being overlapped at a predetermined reference wavelength, photocurrent values of the first wavelength-photocurrent graph being greater than those of the second wavelength-photocurrent graph at wavelengths shorter than the overlapped point while the photocurrent values of the second wavelength-photocurrent graph being greater than those of the first wavelength-photocurrent graph at wavelengths longer than the overlapped point;
a wavelength stabilizing comparator for comparing the photocurrent values respectively outputted from the first QCSE photodetector and the second QCSE photodetector, and outputting a comparing result;
a wavelength stabilizing current control part for receiving a signal outputted from the wavelength stabilizing comparator, and if the photocurrent value outputted from the first QCSE photodetector is different from the photocurrent value outputted by the second QCSE photodetector, changing a current applied to a DBR portion of the DBR LD such that the laser beam outputted from the DBR LD has the reference wavelength;
an adder for outputting a signal value corresponding to a sum of the photocurrents respectively outputted from the first QCSE photodetector and the second QCSE photodetector;
a power stabilizing comparator for comparing the signal value outputted from the adder with a predetermined reference value to output a compared result; and
a power stabilizing driving control part for receiving a signal outputted from the power stabilizing comparator, and if the signal value outputted from the adder is different from the reference value, changing a driving current value of the DBR LD such that an intensity of the laser beam outputted from the DBR LD is changed, thereby stabilizing wavelength and intensity of the laser beam outputted from the DBR LD.

11. The wavelength/optical power stabilizing system of claim 10, wherein the first QCSE photodetector has a different beam absorption characteristic than the second QCSE photodetector, and the first QCSE photodetector and second QCSE photodetector are integratedly formed by a quantum well intermixing technology or a selective growth.

12. A wavelength/optical power stabilizing system comprising:
a wavelength control integration module including (i) an LD for outputting a laser beam, (ii) a light power splitter for dividing the laser beam outputted from the LD, and (iii) a first QCSE photodetector and second QCSE photodetector for receiving beams respectively outputted from the light power splitter and a rear terminal of the LD and a bias voltage from an outside to represent characteristics of a first wavelength-photocurrent graph and a second wavelength-photocurrent graph, the first wavelength-photocurrent graph and the second wavelength-photocurrent graph being overlapped at a predetermined reference wavelength, photocurrent values of the first wavelength-photocurrent graph being greater than those of the second wavelength-photocurrent graph at wavelengths shorter than the overlapped point while the photocurrent values of the second wavelength-photocurrent graph being greater than those of the first wavelength-photocurrent graph at wavelengths longer than the overlapped point, the wavelength control integration module integrating the LD, the light power splitter, and a comparator;
a temperature control circuit and thermoelectric cooler for receiving a signal outputted from the comparator and maintaining a temperature of the wavelength control integration module at a constant value; and
an LD driver for receiving the signal outputted from the comparator, outputting a driving current to control a wavelength of the LD and inputting the driving current to the LD, thereby stabilizing wavelength and intensity of the laser beam outputted from the LD.

13. The wavelength/optical power stabilizing system of claim 12, wherein the LD is a DFB LD or a DBR LD.

14. The wavelength/optical power stabilizing system of claim 12, wherein the first QCSE photodetector has a different beam absorption characteristic than the second QCSE photodetector, and the first QCSE photodetector and second QCSE photodetector are integratedly formed by a quantum well intermixing technology or a selective growth.
